(19) United States
(12) Patent Application Publication
(10) Pub. No.: US 2002/0187751 A1
(43) Pub. Date: Dec. 12, 2002

(54) Apparatus and method for generating a radio data system (RDS) bit clock

(76) Inventors: Stefan Gierl, Karlsruhe (DE); Christoph Benz, Ohlsbach (DE)

Correspondence Address: Samuels, Gauthier & Stevens LLP, Suite 3300, 225 Franklin Street, Boston, MA, 02110, US

(21) Appl. No.: 10/101,446

(22) Filed: Mar. 18, 2002

(30) Foreign Application Priority Data
Mar. 16, 2001 (DE) 101 12 638.7

(51) Int. Cl. H04B 1/00

(52) U.S. Cl. 455/45

(57) ABSTRACT

To generate the RDS bit clock in a car radio, a comparison is made between the period of a clock generator and the period of the demodulated RDS signal. A first counter that triggers the clock generator, counts the zero crossings in the RDS carrier detected by a first zero crossing detector. A second counter counts sampled values of the demodulated RDS signal lying between two zero crossings detected by a second zero crossing detector. If the number of sampled values counted by the second counter lies within a presettable tolerance range, an arithmetic unit calculates a synchronizing signal to synchronize the clock generator with the RDS data stream. The synchronizing signal increments or decrements the count of the first counter to achieve synchronization between the clock generator and the RDS data stream.

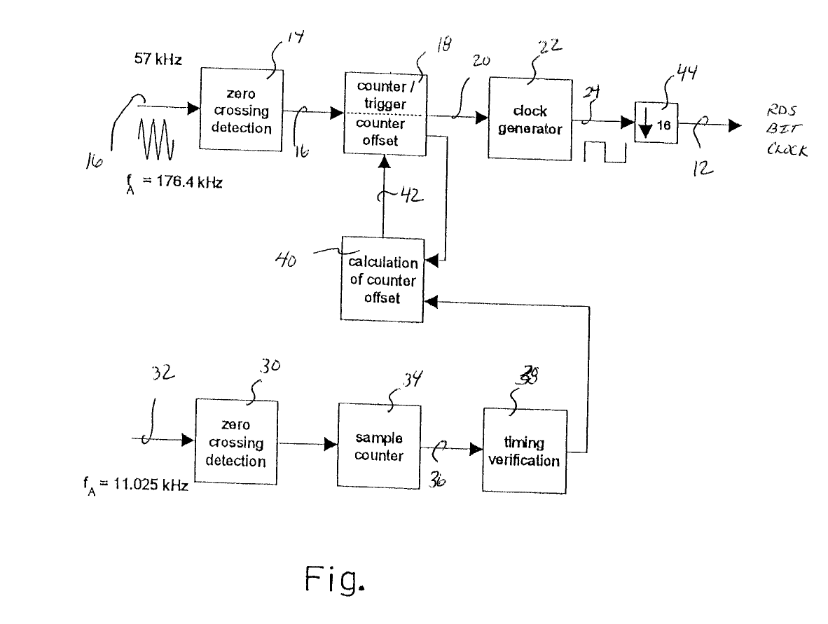

### BACKGROUND OF THE INVENTION

The invention relates to audio systems, and in particular to audio systems that are Radio Data System (RDS) compatible and more specifically to apparatus and method for generating a RDS bit clock signal.

The Radio Data System (RDS) was introduced for use in VHF (i.e., FM) radio stations to broadcast data about the radio station and the program the station is broadcasting. Radio receivers receive this data and reproduce it on an optical display, usually a liquid-crystal display screen. The RDS data may, for example, relate to: the program identification (PI) which indicates the program being received or the name of the station/transmitter tuned in; or the program type identification (PTY) that displays the type of program such as music, news, etc.; or traffic announcements (TA) or radio text (RT) that contains information accompanying the program on, for example, the music title, performer, program changes, and the like.

RDS is used primarily in automobile radios. For example, when the reception of the transmitter currently tuned in degrades, RDS-capable car radios automatically switch over to a better, or best receivable, transmitter broadcasting the same program. The information required to do this includes: the program identification (PI) and the list of alternative frequencies (AF) that are being broadcast by RDS-capable radio stations.

RDS also offers advantages to listeners in non-automotive applications, such as for example a listener of a home receivers. For example, RDS provides the program type identification (PTY) and radio text (RT).

The RDS signal is a binary signal that consists of a continuous binary data stream with a bit rate of 1.1875 kbits/s. Therefore, the RDS bit clock frequency is 1187.5 Hz.

FM radio stations transmit the stereo-multiplex signal that is composed of: (i) the audio center signal up to 15 kHz (also referred to as mono signal); (ii) the stereo pilot tone at 19 kHz; (iii) the stereo signal between 23 kHz and 53 kHz, (iv) and an ARI signal, which is a narrowband amplitude-modulated signal with a carrier frequency of 57 kHz. ARI is the abbreviation for the German phrase Autofahrer-Rundfunk-Information-System or Motorist Information System.

The RDS signal, which has a greater bandwidth than the ARI signal, is superimposed on the ARI signal. To achieve a high data rate for the RDS signal, while preventing the RDS signal from interfering with the audio center signal, the stereo signal, the stereo pilot tone, and the ARI signal, the frequency spectrum of the RDS signal is restricted to ±2.4 kHz. The RDS signal is generated from the RDS data stream by double-sideband modulation with carrier suppression. In addition, the suppressed RDS carrier is phase-shifted by 90° relative to the ARI carrier at 57 kHz. As a result of this quadrature modulation, interference with the ARI signal by the RDS signal is essentially suppressed.

In an RDS-capable radio transmitter, the carrier is frequency-modulated by the stereo-multiplex signal and then transmitted. On the receiver side, the received frequency-modulated carrier is demodulated to obtain the stereo-multiplex signal from which, through demodulation, the RDS signal together with the audio signals and the ARI signal are recovered.

In terms of reception by the car radio, it may take a relatively considerably long time before the car radio is synchronized to the 57 kHz carrier of the RDS signal due to constantly changing and unsatisfactory reception conditions. To accomplish this, the car radio must generate the RDS bit clock at a frequency of 1187.5 Hz from the RDS carrier frequency at 57 kHz. However, since the 1187.5 Hz bit clock frequency is generally not a whole-number fraction of the sampling frequency, the bit clock cannot be generated in a digital system simply by dividing the 57 kHz carrier frequency by 48. While the bit clock is a whole-number fraction of the 57 kHz carrier frequency with a division factor of 48, the sampling frequency at which the digital system operates is not a whole-number fraction, nor a whole-number multiple, of the carrier frequency. As a result, the RDS bit clock cannot be produced by simply dividing the 57 kHz carrier frequency by the divisor 48. The edges of the RDS bit clock over time usually lie between the two sampling values of the clock signal.

Therefore, there is a need to generate an RDS bit clock from a frequency which is neither a whole-number multiple nor a whole-number fraction of the sampling frequency of the clock signal.

### SUMMARY OF THE INVENTION

Briefly, according to an aspect of the invention, a synchronizing signal for synchronizing an RDS clock generator is derived from a comparison of the period of the clock generator with that of a demodulated RDS signal.

The period of the clock generator is compared with the period of the demodulated RDS signal, and from this comparison, a synchronizing signal for synchronizing the clock generator is derived.

A RDS carrier is applied to the input of a first zero crossing detector, the output of which is connected to a first counter; the output of the first counter is connected to the trigger input of the clock generator; the demodulated RDS signal is applied to the input of a second zero crossing detector, the output of which is input a counter input of a second counter; the output of the second counter is connected to the input of an arithmetic unit for calculating a synchronizing signal for the first counter, the correction input of which is connected to the output of the arithmetic unit.

Zero crossings of the 57 kHz carrier of the RDS signal are counted by a first counter that triggers the clock generator. The number of sample values lying between the two zero crossings of the demodulated RDS signal is counted by a second counter. The synchronizing signal for synchronizing the clock generator is calculated from the number of counted sampling values and the last zero crossing. With this synchronizing signal, the first counter is set to the count required for synchronization.

These and other objects, features and advantages of the present invention will become more apparent in light of the following detailed description of preferred embodiments thereof, as illustrated in the accompanying drawings.

### BRIEF DESCRIPTION OF THE DRAWING

The FIGURE is a block diagram illustration of a circuit for generating an RDS bit clock.

### DETAILED DESCRIPTION OF THE INVENTION

The FIGURE is a block diagram illustration of a circuit 10 for generating an RDS bit clock on a line 12. The circuit 10 includes a first zero crossing detector 14 that receives an RDS carrier signal on a line 16. The first zero crossing detector 14 detects the zero crossings in the RDS carrier on the line 14, which has a frequency of 57 kHz and is sampled at a frequency of 176.4 kHz. Counter 18 counts the zero crossings detected by the first zero crossing detector 16. When the count in the counter 18 reaches a presettable value, in this case forty-eight (48), the counter outputs a trigger pulse on a line 20 to clock generator 22. The counter 18 is then also reset to zero. The clock signal on line 24 at the output of the clock generator 22 changes its polarity in response to each trigger pulse received from the counter 18.

A second zero crossing detector 30 receives a demodulated RDS signal on a line 32, and detects the zero crossings of the demodulated RDS signal, which is sampled at a frequency of 11.025 kHz. A sample counter 34 counts the number of sampled values lying between two zero crossings of demodulated RDS signal on the line 32, and provides a count signal indicative thereof on a line 36. A comparison and verification unit 38 compares the number of sampled values counted by the counter 34 with a presettable tolerance range. If the number of sampled values recorded by the counter 34 lies within the presettable tolerance range, which in this embodiment is between 9 and 10 sampling values, an arithmetic unit 40 calculates a synchronizing signal on a line 42, which sets the counter 18 to the count at which synchronization of clock generator 22 is achieved. However, if the number of sampling values counted by the counter 34 lies above or below the presettable tolerance range of between 9 and 10 sampling values, the count of the counter 18 is not corrected.

The comparison and verification unit 38 is required since, for the RDS signal, the period for a binary data change differs from a period with a permanent 1-string or 0-string. By correcting the count for counter 18, the clock generator 22 is synchronized with the RDS data stream.

To obtain the RDS bit clock at a frequency of 1187.5 Hz and sampling rate of 11.025 kHz, the circuit 10 also includes a divider 44, which divides the output signal on the line 24 by a factor of sixteen (16).

An advantage of the technique of the present invention is that the clock generator 22 synchronizes quickly (i.e., the phase-locked loop locks quickly). The technique of the present invention may be implemented in software.

Although the present invention has been shown and described with respect to several preferred embodiments thereof, various changes, omissions and additions to the form and detail thereof, may be made therein, without departing from the spirit and scope of the invention.

What is claimed is:

1. Method for generating the RDS bit clock by means of a clock generator,
characterized in that a synchronizing signal for synchronizing the clock generator is derived from a comparison of the period of the clock generator and the period of the demodulated RDS signal.

2. Method according to claim 1,
characterized in that the clock generator is triggered by a first counter which counts the zero crossings of the RDS carrier, sends, in response to a presettable count, a trigger pulse to the clock generator and is subsequently reset to zero; that the synchronizing signal for synchronizing the clock generator is derived from the number of sampling values between two zero crossings of the demodulated RDS signal and the last zero crossing when the number of sampling values lies in a presettable tolerance range.

3. Method according to claim 2,
characterized in that the synchronizing signal increments or decrements the counter status of the first counter to the correct value.

4. Method according to claim 3,
characterized in that the number of sampling values between two zero crossings of the demodulated RDS signal is counted by a second counter.

5. Method according to claim 4,
characterized in that the clock signal at the output of the clock generator is divided by a presettable factor.

6. Method according to claim 5,
characterized in that the RDS carrier, which has a frequency of 57 kHz, is sampled at a frequency of 176.4 kHz and the demodulated RDS signal (S) is sampled at a frequency of 11.025 kHz, and that the clock signal at the output of the clock generator (CG) is divided by the factor 16.

7. Method according to claim 6,
characterized in that the tolerance range for the number of sampling values of the demodulated RDS signal is from 9 to 10 sampling values between two zero crossings.

8. Method according to claim 7,
characterized in that in response to any count of 48, the first counter sends one trigger pulse to the clock generator and is then reset to zero.

9. Circuitry for generating the RDS bit clock by means of a clock generator,
characterized in that the RDS carrier is applied to the input of a first zero crossing detector, the output of which is connected to the counter input of a first counter; that the output of the first counter is connected to the trigger input of the clock generator; that the demodulated RDS signal is applied to the input of a second zero crossing detector, the output of which is connected to the counter input of a second counter; that the output of the second counter is connected to the input of an arithmetic unit to calculate the synchronizing signal; and that the output of the arithmetic unit from which the synchronizing signal is retrievable is connected to the correction input of the first counter.

10. Circuitry according to claim 9,
characterized in that a comparison and verification unit for checking the count of the second counter is provided between the second counter and the arithmetic unit.

11. Circuitry according to claim 10,
characterized in that the output of the clock generator is connected to the input of a divider, from the output of which the RDS bit clock is retrievable.
